(19) United States
(12) Patent Application Publication
(10) Pub. No.: US 2021/0145007 A1
(43) Pub. Date: May 20, 2021

(54) INSECT BAIT COMPOSITION AND METHODS OF USE OF THE SAME

(71) Applicant: The Texas A&M University System, College Station, TX (US)

(72) Inventors: Spencer T. Behmer, College Station, TX (US); Pierre Lesne, College Station, TX (US)

(21) Appl. No.: 16/949,792

(22) Filed: Nov. 13, 2020

Related U.S. Application Data
(60) Provisional application No. 62/935,173, filed on Nov. 14, 2019.

(51) Int. Cl. A01N 63/10; A01N 37/06; A01N 25/26; A01N 65/20; A01N 65/08; A01N 43/707; A01N 43/88; A01N 47/30; A01N 47/00; A01N 37/08; A01N 47/40; A01N 43/78; A01N 43/50; A01N 43/40

(52) U.S. Cl. CPC A01N 63/10; A01N 37/06; A01N 25/26; A01N 65/20; A01N 65/08; A01N 43/707; A01N 43/40; A01N 47/30; A01N 47/00; A01N 37/08; A01N 47/40; A01N 43/78; A01N 43/50; A01N 43/88

(57) ABSTRACT

Disclosed herein are bait formulations for attracting and controlling pest insects such as ants. The bait compositions include a specific ratio of lipids and protein sources that are effective in both discovery and recruitment and are superior to current commercial ant bait formulations as they are effective throughout the different seasons and against diverse species of ants. The ant bait compositions may be combined with an insecticide to reduce or eliminate ant populations. Methods for making and using the compositions are also disclosed.

### CROSS-REFERENCE TO RELATED APPLICATION

This application claims priority under 35 U.S.C. § 119 to Provisional Application U.S. Ser. No. 62/935,173, filed on Nov. 14, 2019, which is herein incorporated by reference in its entirety including without limitation, the specification, claims, and abstract, as well as any figures, tables, or examples thereof.

### FIELD OF THE DISCLOSURE

The disclosure relates to an insect bait composition, which is effective in both recruitment and discovery for ant species. The invention further relates to insecticidal compositions comprising an insecticide and the bait composition as well as methods of use of the same.

### BACKGROUND

It is desirable to control invasive and nuisance insect populations to prevent injury to humans and animals, to prevent the displacement of native species, or to eliminate the general nuisance caused by some insect species, particularly ants. The problems caused to individuals by the presence of ants in living areas or in the immediate vicinity thereof, such as in the lawns, gardens or on the patio can be a major concern. The presence of ants around a house or other structure may be particularly unpleasant for the resident because of the bites or stings inflicted by certain species or general nuisance. The control of ants is also desirable regarding the cultivation of fruit trees and/or ornamentals. Certain species of ants play a role in defending aphids against their predators which contributes toward maintaining high populations of aphids, which are harmful to the health of the trees and/or to fruit yields. Some ant species may create nests inside living areas, which, in the case of blocks of flats and hospitals, may pose hygiene problems.

Current ant baits and methods are not providing adequate control. They often destroy only a small portion of the population concerned. For example, in the case of ants, only a fraction of the worker ants (˜10%) provide the function of collecting food outside the nest. The destruction of these foraging worker ants is not sufficient to kill the population. Indeed, the ability of ants to proliferate and their specialization based on the needs of the nest are capable of rapidly compensating for this destruction, bringing about an increase in the population. The known methods of controlling ants also suffer from the complications associated with inaccessible nests, making it difficult to treat the entire population. They are difficult to locate, or often occur at a depth of several tens of centimeters below the surface of the ground.

Another disadvantage of known ant baits is they are specific to certain ant species. Usually several different species of ants live in a specific area in which said ants may be desired to be controlled. Current baits are generally designed to be attractive to either the so-called “oil-loving” ant species or “sugar-loving” ant species. Generally, species of invasive or pest ant belong to either “oil-loving” ants or “sugar-loving” ants, therefore current baits are not attractive to both classes of invasive and pest ants. Additionally, each species has slightly different preferences for food, and these preferences can change depending upon the time of year. As a result, only populations of certain species are controlled, which may change throughout the year. Similarly, manufacturers of ant baits must produce specific bait compositions for various regions of the world, depending on the ant species in the respective region.

Another disadvantage of current baits is their formulations. It is desirable for the ant bait to be easy and safe to handle, however some baits are dusty which may lead to undesirable or dangerous contamination of the persons who apply it. Further, some ant baits are in non-solid state, such as a gel or liquid, resulting in the need for special application equipment or tending to evaporate at elevated temperatures.

A further disadvantage of known baits is that they can be inactivated by water. This poses a problem because the bait cannot be used during or right after precipitations or when precipitation is forecasted. The bait also cannot be used in the morning because of morning dew.

Another problem is that known baits they are not specific enough to invasive or pest species. It is often desirable to control only the populations of pest ants to restore the native ant population. A strong native ant community will prevent invasive or pest ant populations to spread again. It is also desirable to control only the species that constitute a health threat (e.g., the red imported fire ant, Solenopsis invicta) and leave the other ant species.

Due to these issues with current baits, there is a need to have an ant bait that is attractive to both “sugar-loving” and “oil-loving” ants throughout the entire year and in multiple regions.

### SUMMARY

The bait composition disclosed herein is attractive to diverse species of ants across a wide range of seasons and environments both in terms of discovery and recruitment and is superior to current commercial ant bait formulations, especially in terms of number of ants recruited to the bait. Applicants have identified a range of lipid-protein compositions and ratios that are attractive to diverse species of ants, particularly pest species, throughout the seasons. The bait composition comprises from about 5 wt. % to about 55 wt. % of a filler/binder, about 20 to about 70 wt. % of a protein source, and about 5 to about 45 wt. % lipid. In some embodiments, the ratio of protein source to lipid ranges from about 3:1 to about 1:3. In a preferred embodiment the ratio of protein source to lipid is 2:1 by weight. In a preferred embodiment the protein is whey or egg white and comprises 20 to 70 wt. % of the bait composition. The lipid component comprises a combination of linoleic and linolenic acids preferably in a ratio of about 3:1 to about 1:2.

The bait may be used alone to assess the composition of the ant community, or may be combined with an insecticide or any other agent desired to be introduced to an ant colony to form an insecticidal, sterilization, or other control composition. The insecticidal compositions comprise the ant bait, insecticide or other agent desired to be introduced to an insect colony, and an optional carrier. In certain embodiments the insecticidal composition is encapsulated in a capsule. In other embodiments the bait may be loaded into a station which can be used to capture the ants attracted to the bait and the ants collected that way can be used to determine the presence of invasive ants, pest ants, or any insect species of interest in the area tested. When used in this purpose, the bait can be combined with an insecticide or not.

In some aspects the present disclosure relate to methods for eliminating insects. The methods comprise applying to the ants or an area inhabited by the ants an insecticidal composition disclosed herein.

### BRIEF DESCRIPTION OF THE DRAWINGS

FIG. 1A is a graphical representation of the percent of vials filled with compositions as disclosed herein having variable amounts of protein source which were discovered by ants in a temperate region. FIG. 1B is a graphical representation of the number of ants recruited per vial filled with compositions as disclosed herein having variable amounts of protein source. The letters above the bars represent statistically significant differences and bars sharing a letter are not statistically different.

FIG. 2A is a graphical representation of the percent of vials filled with compositions as disclosed herein having variable types of protein source which were discovered by ants in a temperate region. FIG. 1B is a graphical representation of the number of ants recruited per vial filled with compositions as disclosed herein having variable types of protein source. The letters above the bars represent statistically significant differences and bars sharing a letter are not statistically different.

FIG. 3A is a graphical representation of the percent of vials filled with compositions as disclosed herein having a protein source, a lipid source, or a combination of a protein source and a lipid source which were discovered by ants in a temperate region. FIG. 3B is a graphical representation of the number of ants recruited per vial filled with compositions as disclosed herein having a protein source, a lipid, or both. The letters above the bars represent statistically significant differences and bars sharing a letter are not statistically different.

FIG. 4A is a graphical representation of the percent of vials filled with compositions as disclosed herein having variable types of lipid which were discovered by ants in a temperate region. FIG. 4B is a graphical representation of the number of ants recruited per vial filled with compositions as disclosed herein having variable types of lipid. The letters above the bars represent statistically significant differences and bars sharing a letter are not statistically different.

FIG. 5A is a graphical representation of the percent of vials filled with compositions as disclosed herein having variable types of lipid which were discovered by ants in a rainforest. FIG. 5B is a graphical representation of the number of ants recruited per vial filled with compositions as disclosed herein having variable types of lipid. The letters above the bars represent statistically significant differences and bars sharing a letter are not statistically different.

FIG. 6 is a graphical representation of the relative proportion of ants being recruited between to two different lipids over time.

FIG. 7A is a graphical representation of the percent of vials filled with compositions as disclosed herein having variable ratios of a protein source to lipids which were discovered by ants. FIG. 7B is a graphical representation of the number of ants recruited per vial filled with compositions as disclosed herein having variable ratios of protein to lipids. The letters above the bars represent statistically significant differences and bars sharing a letter are not statistically different.

FIG. 8A is a graphical representation of the changes of discovery of bait due to changes in the preferences of ants over the course of the year to the different compounds or group of compounds of the compositions as disclosed herein in a lawn habitat. FIG. 8B is a graphical representation of the changes in the preferences of ants over the course of the year to the different compounds or group of compounds of the compositions as disclosed herein in a lawn habitat.

FIG. 9A is a graphical representation of the changes of discovery of bait due to changes in the preferences of ants over the course of the year to the different compounds or group of compounds of the compositions as disclosed herein in a wooded habitat. FIG. 9B is a graphical representation of the changes in the preferences of ants over the course of the year to the different compounds or group of compounds of the compositions as disclosed herein in a wooded habitat.

FIG. 10A is a graphical representation of a comparison in the percent of vials discovered of a commercially available bait to a composition as disclosed herein. FIG. 10B is a graphical representation of a comparison in the number of ants recruited to vials filled with either a commercially available bait or a composition as disclosed herein.

FIG. 11 is a graphical representation of a comparison between the percentage of ants recorded at a bait composition as disclosed herein compared to two commercially available baits.

### DETAILED DESCRIPTION

So that the present disclosure may be better understood, certain terms are first defined.

As used herein, “weight percent”, “wt. %”, “percent by weight”, “% by weight”, and variations thereof refer to the concentration of a substance as the weight of that substance divided by the total weight of the composition and multiplied by 100. It is understood that, as used here, “percent”, “%”, and the like are intended to be synonymous with “weight percent,” “wt.-%,” etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

As used herein, the term “solid” refers to a composition or material in a solid state. Solids can include powders, pastes, prills, beads or flakes.

As used herein, the term “protein source” is a component of the compositions which provides the main source of protein as an ant attractant. The nonlimiting examples of whey, egg white, soy, yeast, rice, or peas are protein sources even though the amount of protein may vary from source to source. Any other component in the protein source does not increase the attractiveness of the compositions to ants. For example, commercially available whey powders may be as little as 10% protein, whereas whey protein may be 30% protein, whey concentrates may be 80% protein and whey isolates may be about 90% protein but the other main components, for example lactose, do not attract ants. Other protein sources, such as egg white, may be almost 100% protein, while others may be 10% or less.

The term “substantially free” may refer to any component that the composition of the disclosure or a method incorporating the composition lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

As used herein, the term “ant colony” or “colony” is defined as the basic unit around which ants organize their lifecycle. It refers to the collections of workers, reproductive individuals, and brood that live together, cooperate, and treat one another non-aggressively.

As used herein, the term “ant species” or “species” is defined as the basic unit of biological classification and a taxonomic rank. As a biological term, a species is often defined as the largest group of organisms in which any two individuals of the appropriate sexes or mating types can produce fertile offspring, typically by sexual reproduction By definition, different ant species cannot interbreed with another.

As used herein, the term “ant population” or “population” is defined as the number of all the ants of the same species who live in a particular defined area and are capable of interbreeding.

As used herein, the term “ant community” or “community” is defined as an assemblage of populations of different ant species, interacting with one another in a defined area.

As used herein, the term “ant pest” or “pest” is defined as any ant species/population that is harmful to humans or human concerns. The term is particularly used for ants that cause a nuisance to people, especially in and around their homes/places of work.

As used herein, the term “introduced” describes any process by which the insecticide enters the colony to be fed to colony members. This includes spraying, broadcasting or the process by which foraging ants collect the bait laced with insecticide and return it to the colony where it is shared with the non-foraging members of the colony by the ants themselves.

### Bait Composition

The disclosure includes a solid bait composition which may be combined with an insecticide to form an insecticidal composition. The solid bait disclosed herein includes a specific protein source to lipid ratio which surprisingly increases both discovery of the bait as well as insect recruitment for the widest possible application for environment and season. The ratio of protein source to lipid in the bait composition may be from about 3 to 1 to about 1 to 3 by weight. Preferably the ratio may be from about 2.5:1 to about 1:1.5. A ratio of 2 to 1 by weight of protein component to lipid component is most preferred. The protein source is most preferred in the amount of from about 20% by weight to about 70% by weight of the bait composition.

The bait composition comprises from about 5 to about 55 wt. % polysaccharide filler/binder, about 20 to about 70 wt. % protein source, and about 5 to about 45 wt. % lipid. Preferably from about 10 to about 50 wt. % cellulose, about 25 to about 65 wt. % protein source, and 10 wt. % and about 40 wt. % lipid; and most preferably from about 20 to about 40 wt. % cellulose, from about 30 to about 60 wt. % protein source, and from about 15 to about 35 wt. % lipid. In an embodiment, the ratio of protein source to lipid is preferably 2:1. The bait composition may be combined with an insecticide to create an insecticidal composition.

### Lipid

As used herein, a “lipid” includes fats, oils, triglycerides, cholesterol, phospholipids, fatty acids in any form including free fatty acids. Fats, oils, and fatty acids can be saturated, unsaturated (cis or trans) or partially unsaturated (cis or trans). In some embodiments, the lipid comprises at least one fatty acid selected from lauric acid (12:0), myristic acid (14:0), palmitic acid (16:0), palmitoleic acid (16:1), margaric acid (17:0), heptadecenoic acid (17:1), stearic acid (18:0), oleic acid (18:1), linoleic acid (18:2), linolenic acid (18:3), octadecatetraenoic acid (18:4), arachidic acid (20:0), eicosenoic acid (20:1), eicosadienoic acid (20:2), eicosatetraenoic acid (20:4), eicosapentaenoic acid (20:5) (EPA), docosanoic acid (22:0), docosenoic acid (22:1), docosapentaenoic acid (22:5), docosahexaenoic acid (22:6) (DHA), and tetracosanoic acid (24:0). In an embodiment, the lipid component may be from about 3 to 1 to about 1 to 3. Preferably the ratio may be from about 2:1 to about 1:2. In a preferred embodiment, applicants have identified that the lipid component is preferably a combination of linolenic and linoleic fatty acids. In a most preferred embodiment, the fatty acids are present at an approximate ratio of 1:1.

In some embodiments, the fatty acids are presented in a source of naturally occurring oils such as soybean, or safflower oils, and the like. The lipids preferably are rich in Omega 3 fatty acids, where the double bonds are interrupted by methylene groups, and the seed and vegetable oils containing them may be used. Mixtures of fatty acids and of vegetable or seed oils, plant oils, may be used. Examples of oils which may be used in the invention, include but are not limited to, corn oil, castor oil, soybean oil, safflower oil, sunflower oil, linseed oil, tall oil fatty acid, tung oil, vernonia oil, and mixtures thereof. The specific oils are preferably combined to create a 1:1 ratio of linolenic to linoleic acid. In a most preferred embodiment, the oils are a mixture of soybean oil and linseed oil.

In some embodiments, the lipid component is present in the bait compositions at an amount of about 5 wt. % to about 45 wt. %, about 10 wt. % to about 40 wt. %, or about 15 to about 35 wt. %. It is to be understood that all ranges and values between these ranges and values are encompassed by the present compositions.

### Protein Source

The protein source is usually a composition comprising polyamino acids from natural or synthetic origin, preferably from natural origin that is typical in the ant diet. Typically, the protein source has a crude protein content comprised between 5 wt. % and 25% wt. %, preferably between 5 wt. % and 35 wt. %, more preferably between 5 wt. % and 55 wt. %, even more preferably between 5 wt. % and 75 wt. % and most preferably between 5 wt. % and 95 wt. % based on dry matter of the protein source. The crude protein content may be determined by known methods, which are generally suitable for the respective protein source. Preferably, the crude protein content is determined by the Kjeldahl method for the crude protein content, such as DIN EN ISO 5983-1 “Animal feeding stuffs—Determination of nitrogen content and calculation of crude protein content. Part 1: Kjeldahl method” from October 2005. For plant protein, the DIN EN ISO 20483 “Cereals and pulses—Determination of nitrogen content and calculation of crude protein content—Kjeldahl method” from February 2007 is especially preferred. For milk proteins, the ISO TS 17837 EN “Milk and milk products—Determination of nitrogen content and calculation of crude protein content—Kjeldahl method” from March 2008 is especially preferred. Examples of proteins from natural sources are milk proteins (such as casein, sodium casein, calcium casein, lactalbumin, dried milk, whey), plant protein (such as gluten, e.g. from wheat; soy extract, peanut extract, zein), animal protein (such as fish meal, meat meal, egg white, liver powder (e.g. from chicken liver or poultry liver), collagen, dried insects, such as crickets) or yeast. Preferred protein is whey or egg white. While not wishing to be bound by any theory it is thought that the amino acid content of these two proteins are highly attractive to the ants and any protein source with the same amino acid profile will likely be acceptable.

### Binder/Filler

Preferred polymeric binders/fillers are polyvinylpyrrolidone and polysaccharides. Preferred polysaccharides are cellulose derivatives, preferably cellulose derivatives that are usually prepared by chemical, polymer analogous reactions of cellulose. Preferred cellulose derivatives are cellulose esters, such as cellulose acetate or cellulose butyrate, and cellulose ethers, such as carboxymethyl cellulose, methyl cellulose, methylhydroxyalkyl cellulose, hydroxyethyl cellulose, carboxymethyl hydroxyethy cellulose, ethyl cellulose, ethyl hydroxyethyl cellulose, hydroxypropyl cellulose. More preferred polymeric binder are cellulose ethers, especially methyl cellulose.

### Insecticide

The ant bait also includes an insecticide to form an insecticide composition. The term “insecticide” within the meaning of the disclosure states that one or more insecticide can be selected. Preferably, one or two, insecticides are selected. The skilled artisan is familiar with such insecticides, which can be, for example, found in the Pesticide Manual, 13th Ed. (2003), The British Crop Protection Council, London. Examples for insecticides are: organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon; carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate; pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin; insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat; ] nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane; GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carb-othioic acid amide; macrocyclic lactone insecticides: abamectin, emamectin, milbemectin, lepimectin, spinosad, spinetoram; mitochondrial electron transport inhibitor (METI) I acaricides: fenazaquin, pyridaben, tebufenpyrad, tolfenpyrad, flufenerim; METI II and III compounds: acequinocyl, fluacyprim, hydramethylnon; Uncouplers: chlorfenapyr; oxidative phosphorylation inhibitors: cyhexatin, diafenthiuron, fenbutatin oxide, propargite; moulting disruptor compounds: cryomazine; mixed function oxidase inhibitors: piperonyl butoxide; sodium channel blockers: indoxacarb, metaflumizone; others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, borate, BT protein, paracite, bacteria, virus, fungus, and pyrifluquinazon.

Typically, an insecticide especially effective for controlling ants is selected. Preferably, the insecticide is metaflumizone, fipronil, or metaflumizone and fipronil.

In another preferred embodiment the insecticide is selected from the group of pyrethroids, GABA antagonist compounds, sodium channel blocker compounds, nicotinic receptor agonists/antagonists compounds, and uncoupler compounds. Particular preferred compositions contain at least one insecticide compound selected from the group consisting of bifenthrin, tefluthrin, α-cypermethrin, lambda cyhalotrin, ethiprole, pyriprole, fipronil, metaflumizone, acetamiprid, clothianidin, imidacloprid, nitenpyram, thiacloprid, thiamethoxam, dinetofuran, and chlorfenapyr.

In another preferred embodiment, the insecticide is selected from the group of pyrethroids, in particular selected from bifenthrin, tefluthrin α-cypermethrin or lambda cyhalotrin.

In another preferred embodiment, the insecticide is selected from the group of 5 GABA antagonist compounds, in particular selected from ethiprole, pyriprole and fipronil.

In a further preferred embodiment, the insecticide is selected from the group of sodium channel blocker compounds, in particular metaflumizone.

In a further preferred embodiment, the insecticide is selected from the group of nicotinic receptor agonists/antagonist compounds, in particular selected from acetamiprid, clothianidin, imidacloprid, nitenpyram, thiacloprid, thiamethoxam and dinetofuran.

A further preferred embodiment, the insecticide is selected from the group of uncoupler compound, in particular chlorfenapyr.

In a most preferred embodiment, the insecticide is one which is slow acting, allowing sufficient time for the ants to carry the formulation to the nest, and ultimately to the queen. Typically, this is one which has a delay of 48 to 72 hours before killing. The solid insecticide composition according to the disclosure may comprise from 0.005 to 5 wt. % insecticide, preferably from 0.01 to 3.5 wt. %, more preferably from 0.05 to 2 wt. %, relative to the ant bait.

### Additional Additives

The bait composition may comprise further additives, for example an anti-oxidizing agent, a preservative, a coloring agent, a flavoring agent or a feed attractant. Such additives are usually added in amounts, which are well known to the expert.

Examples of the anti-oxidizing agent are erythorbic acid, sodium erythorbate, di-tert-butyl hydroxytoluene (BHT), dl-alpha-tocophelol, nordihydroguaiaretic acid, methylhydroxyanisole, propyl gallate, guaiac resin, L-cysteine hydrochloride.

Examples of the preservative are benzoic acid, sodium benzoate, salicylic acid, diphenyl, sorbic acid, potassium sorbate, dehydroacetic acid, sodium dehydroacetate, isobutyl p-oxybenzoate, isopropyl p-oxybenzoate, ethyl p-oxybenzoate, butyl p-oxybenzoate, propyl p-oxybenzoate, calcium propionate, sodium propionate, 2-methyl-4-isothiazolin-3-one (MIT), 1,2-benzisothiazolin-3-one (BIT) (mixtures of MIT and BIT are commercially available as Acticide® MBS from Thor), 1,2-Benzisothiazolin-3-one, 2-Bromo-2-nitropropane-1,3-diol or 2-Methyl-3(2H)-isothiazolone (mixtures of the latter three compounds are commercially available as acticide MBL 5515 from Thor). Examples of a coloring agent is a dye or a pigment, such as Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, amaranth, amaranth aluminium lake, erythrosine, erythrosine aluminium lake, new coccine, Phloxine, rose bengal, acid eed, tartrazine, tartrazine aluminium lake, Sunset Yellow FCF, Sunset Yellow FCF aluminium lake, Fast Green FCF, Fast Green FCF aluminium lake, Brilliant Blue FCF, Brilliant Blue FCF aluminium lake, indigo carmine, indigo carmine aluminium lake, beta-carotene, copper chlorophyll.

Examples of the flavoring agent are cheese flavor, butter flavor, peanut flavor, peach flavor, strawberry flavor, milk flavor.

Examples of the feed attractant are essential oils such as olive oil, soybean oil, rapeseed oil, sesame oil, cotton seed oil, wheat germ oil, corn oil, sunflower oil, palm oil, castor oil, and linseed oil.

In a preferred embodiment, the amounts of various components of the bait composition may be selected such that a solid ant bait is formed. Typically, the amounts of the components add up or may be filled up with other formulation additives to 100 wt %. Regarding the attractiveness to ants of the bait composition, it is well known in the art that there is no difference between baits containing insecticide or without insecticide.

### Preparation of the Composition

Any number of methods can be used to prepare the ant bait compositions disclosed herein. The method employed is dependent upon the type of formulation to be prepared, for example a paste, liquid, emulsion, pressed solid, or granular. While the bait may be formulated in a variety of ways, in a preferred embodiment, the process of preparing the insecticide composition comprises mixing the solid components of the bait composition, including the optional insecticide, to form mixture of powders, and then adding the lipid components of the bait composition to form a flaky paste in some embodiments of the bait composition. In some embodiments the insecticide composition may be prepared by a process comprising extruding a mixture which contains the insecticide and the bait composition. Usually, the process further comprises drying of the extruded or pelleted mixture, preferably extruded. Preferably, the ant bait according to the disclosure is obtained by extrusion of a mixture comprising the insecticide and the bait composition.

Extruders are well known in the art. For example, a one screw or twin-screw extruder may be used. Also, extruders used for producing spaghetti may be used. Typically, the extrusion is accomplished at a pressure (usually taken just before entering into the extrusion grid) from 1 to 80 bars, preferably from 1 to 60 bars, and more preferably from 1 to 40 bars. Typically, the extrusion is accomplished at a temperature from 10 to 100° C., preferably from 20 to 80° C., and more preferably from 30 to 60° C. Said temperature refers to the paste during extrusion. When necessary, the temperature is maintained at the desired value by cooling. An extrusion grid may be used with holes of any shape, preferably of circular shape. Typically, the diameter of the holes is from 0.2 to 5.0 mm, preferably from 0.5 to 3 mm, more preferably from 0.5 to 2.0 mm. The extrudate may be dried to lower the water content of the extrudate. Drying may be done by the application of elevated temperatures, such as hot air, from 30 to 150° C., preferably from 50 to 80° C. The heating time depends on the temperature, the size of the extrudate and the desired amount of water in the final product.

The stick-like extrudate may be cut, e.g. with a rotating knife, into shorter sticks before or after drying, preferably before drying. In the case of circular holes, the spaghetti-shaped extrudate may be cut into cylindrical shape. In case of polygonal holes (e.g. triangular or rectangular), the extrudate may be cut into corresponding shapes. The resulting pellets might be broken into shorter granules before or after drying, preferably after drying. Preferably, the resulting granules have cylindrical shape with a length of 0.2 to 2 mm and a diameter of 0.2 to 2 mm. In another preferred embodiment, the resulting granules have a shape, which has length of 0.2 to 2 mm at its most distant points, and a diameter of 0.2 to 2 mm at its broadest diameter.

The ant bait according to the disclosure may be a solid ant bait. Preferably, the solid ant bait is mixture of small solid granules. These granules may have a shape, which has length of 0.2 to 2 mm at its most distant points, and a diameter of 0.2 to 2 mm at its broadest diameter. Usually, solid state of matter is characterized by a distinct structural rigidity and virtual resistance to deformation (that is changes of shape and/or volume). Usually, solids have high values both of Young's modulus (e.g. at least 0.1 GPa) and of the shear modulus of elasticity (e.g. at least 0.01 GPa).

In another embodiment, the compositions may be formulated into a liquid when added to an appropriate solvent, such as, but not limited to, water or a lipid. This may allow for long-term delivery using systems such as liquid gravity feed systems. The individual compounds may be mixed with the solvent directly, or may first be mixed, the mixture encapsulated, and then mixed with the solvent to form an emulsion or suspension of the compounds.

The compositions of the disclosure may also be encapsulated. The capsule around the compositions may be different forms, for example, in one embodiment, it can be a form of plastic with perforations or slits or easily torn, that holds the compositions encased within until pressure is released by the capsule being removed. Removal may occur, for example, by the ant applying pressure. In another embodiment, the capsule may be a layer that is made of a different material, natural or artificial, but will join, fuse, meld together to attractants and that will tear away from the compositions when the capsule is removed, allowing the compositions to spill out. In still another embodiment, the capsule may be a biodegradable compound, such as, but not limited to, alginate, that will deteriorate over time. The size of the capsule may be nanosized, under 1,000 nm, microsized, under 1,000 μm, or larger, under 1,000 mm, where larger capsules may form into a hydrogel matrix.

The compositions may also be placed inside a station. Any bait station may be used, for example a flat or upright station, and are known in the art. A preferable station is an elongated hollow tube with a single opening at one end of the tube and wherein the opposite end of the tube is sealed. The bait may then be loaded into the sealed end of the tube. The bait station may made of plastic or a biodegradable material. The station may be a one-time use, refillable, or may be sealed after use.

### Use of the Composition

In another aspect of the disclosure, a method is provided for controlling ants, comprising introducing to said ants the ant bait disclosed herein. Preferably, the ant species the bait is introduced to include, but are not limited to, Argentine ants (Linepithema humile), Big-headed ants (Pheidole spp.), Odorous house ant (Tapinoma sessile), Fire ants (Solenopsis spp.), Crazy ants (Paratrechina spp. and Nylanderia spp.) and Lasius spp. More preferably, at least two species of ants, which are present in the same area and are selected from Argentine ants (Linepithema humile), Big-headed ants (Pheidole spp.), Odorous house ant (Tapinoma sessile), Fire ants (Solenopsis spp.), Crazy ants (Paratrechina spp. and Nylanderia spp.) and Lasius spp., are controlled.

Populations of ants may be controlled using the method according to the disclosure. Control of a population of ants is understood to mean the control of the said population, and more particularly the total or almost total destruction of the said population, in other words the destruction of more than 60%, preferably more than 70% and even more preferably of 95% to 100%, of the said population. In this case, the minor fraction of the population to which the ant bait is applied generally consists of workers whose function is to collect food from outside the nest, these being known as the foragers of the nest.

An effective amount of the composition used in the method according to the disclosure is understood to mean an amount which is capable of controlling the whole population of ants. More particularly, the disclosure relates to a method for treating ants with an effective amount of the ant bait according to the disclosure, this effective amount of composition being an amount used equal to the dose required to destroy at least 90% of the minor fraction of the population of social insects to which the said composition is applied, within a period of between 2 and 30 days, preferably between 2 and 7 days. The minor fraction often corresponds in practice to the population living or circulating outside the common dwelling place or nest. Typically, an effective dose is between 0.0001 and 20 grams per 100 m², of one or more areas frequented by, or assumed to be frequented by, the said ants, the said area being outside the place of the said common dwelling but being a place in which the ants circulate or are assumed to circulate.

The solid ant bait may be applied by various methods, such as broadcasting it over a large area or by a bait carrier box. For example, liquid formulations may be sprayed in a target area or hydrogels and pastes may be directly applied to the ground. In a preferred embodiment, the application method is to disperse bait as a paste in bait stations in a target area at intervals sufficient to provide control of invasive species in that area, where an insecticide is included with the bait. Thus, foraging ants outside of the nest may be attracted to the bait and may pick up the bait and insecticide and return them to the nest where the insecticide is passed to other colony members. One or more ant populations can be controlled using this method.

Another application includes using the bait composition without insecticide in a station capable of restricting the movement of the ants in order to capture the ants attracted to the bait. The station may use, by way of non-limiting example, any trap known in the art, for example a pitfall trap, a liquid trap, or a sticky trap to capture the ants. Preferably, station is an elongated tube with a single, closable opening at one end to capture the ants within the station. Due to the high attractiveness of the bait, ants may be collected in the bait at the bottom of the station. The station may be introduced to the ants by placing the station in a desired area for a sufficient amount of time to attract ants. The station may be places above ground or imbedded into the ground with an opening exposed to the surface of the ground allow ants to be attracted to the bait. In a preferred embodiment, the amount of time may be from about 5 minutes to about 120 minutes, from about 10 minutes to about 100 minutes, or from about 15 minutes to about 60 minutes. The identification of the ants captured informs on the presence of invasive ants, pest ants, or on the composition of the ant community. This information can be used to inform a decision on the need to apply or re-apply the bait composition combined with the insecticide. One or more ant populations can be counted using this method.

Other applications may include using a liquid gravity feed system to deliver the compositions over an extended time. This may also allow the incorporation of the compounds with other baits or treatments so it may be included in broader pest control.

The present disclosure offers various advantages: The ant bait according to the disclosure, is similarly attractive to ant species in various different environments. Ants have been shown to prefer different protein and lipid sources in different environments and different times of the year. The bait of the disclosure is widely applicable across all seasons and environments.

Further, the process according to the disclosure, especially the paste or extrusion process for producing the ant bait, is suitable for industrial mass production. The process yields an ant bait, which is safe, easy to handle and dust-free. The ant bait can be utilized worldwide with available machinery. Another advantage of the preferred paste is the solid state of the ant bait, which allows strewing of the ant bait by hand or with the help of strewing devices. Further, solid ant baits are much easier to handle and apply compared to gels or putties. Even in warmer climates or application zones the solid baits remain in their desired shape and can easily take away by the ants in this shape.

The disclosure is further illustrated by the following examples, which should not be construed as further limiting.

### EXAMPLES

### Example 1

Samples were formulated as a paste and placed in plastic Eppendorf microtubes (1.9 ml). Vials were randomly placed every meter along a transect in the environment. Each treatment was replicated 10 times per transect. The number of treatments varied between experiments. Each transect was replicated 6 times per experiment.

### Varying Amounts of Protein

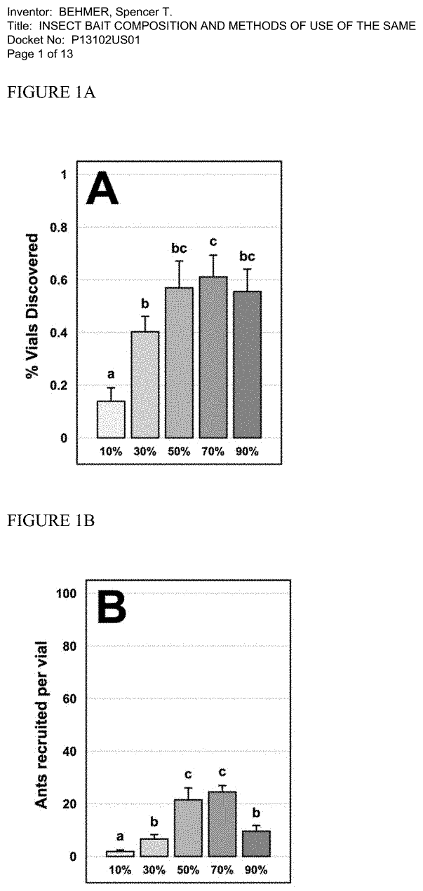

For the first experiment, a paste was made of varying amounts of a protein source with the remainder comprising cellulose to form 66% by weight of the composition. This was then combined with 33% water and spread in a temperate region of Texas. The results are shown in FIGS. 1A and 1B.

As can be seen, the most vials were discovered (presence of an ant in vial; FIG. 1A) by the ants at a composition of between about 40% to about 80% of the protein source. For recruitment, (total number of ants in vial, FIG. 1B) the preferred range narrows to 50 to 70% of the protein source. Therefore, the ant baits are effective across a broad range of protein source amounts.

### Varying Types of Protein

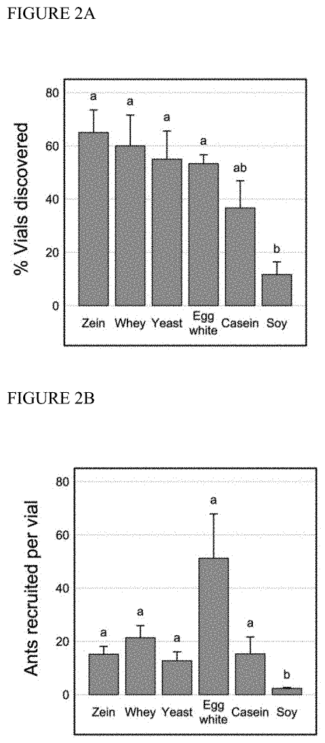

Next different types of protein were tested in a similar manner. Proteins sources tested include zein, whey, brewer yeast, egg white, casein and soy protein. The results are shown in FIGS. 2A and 2B. As can be seen in the figures, the ants show little differences in preference for a protein source type. Only the soy protein is associated with significantly lower discovery (FIG. 2A) and recruitment (FIG. 2B). While not wishing to be bound by any theory it is suspected that the amino acid profile of these proteins that is desirable. Similar amino acid profiles from various other combinations of proteins, either artificial or natural, would be expected to produce similar results.

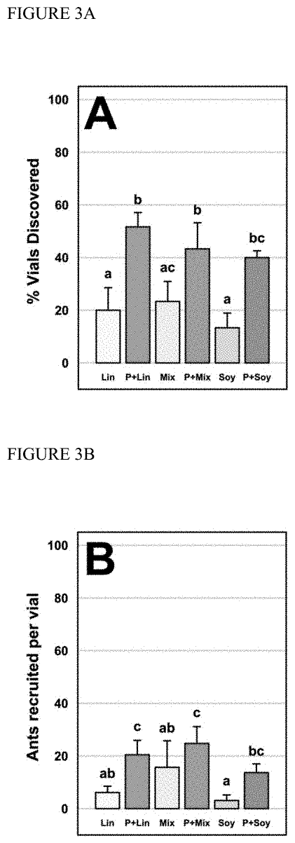

As shown in FIGS. 3A and 3B, proteins source (P) paired with different lipids (Lin: Linseed oil; Soy: Soybean oil; Mix: Combination of soybean and linseed oil) were tested. As can be seen in FIGS. 3A and 3B protein source plus lipid is always better than lipid alone. Also, this shows there is no difference in lipid type when paired with protein source in terms of recruitment (FIG. 3B)).

### Varying Types of Lipids

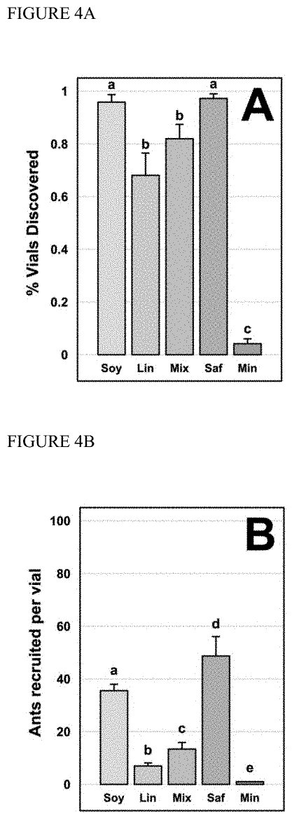

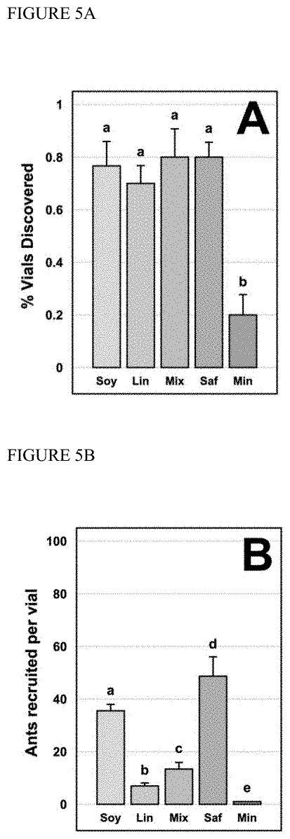

For the next experiment different lipids were tested in a temperate region of Texas. For these tests, oil saturated pieces of cotton were placed at the bottom of the vials. Oils tested included soy, linseed, safflower, and mineral oil (used as a negative control). The components of the various oils tested are showing the Table 1. The results of the testes with different lipids are shown in FIGS. 4A and 4B.

TABLE 1

| | Saturated FA | Oleic acid | Linoleic acid | α -Linolenic acid |
|---|---|---|---|---|
| Oil Type | (%) | (%) | (%) | (%) |
| Soybean | 15.6 | 22.6 | 51 | 7 |
| Linseed | 9 | 18 | 13 | 53 |
| Soy/Lin Mix | 12.3 | 20.3 | 32 | 30 |
| Safflower | 7.5 | 75.2 | 12.8 | 0 |

This experiment shows that ants can discriminate between different types of oils and display strong preferences. For instance, ants in this experiment show a preference for soybean and safflower oil over linseed oil and the mix of linseed and soybean oil. This result contrasts with the previous experiment that showed a very low attraction for soybean oil and a preference for the mix of soybean and linseed oil. To further illustrate the variability in oil preference depending on context, we conducted similar experiments in different habitats. First, the experiment was replicated in a rainforest in Costa Rica. The results are presented in FIGS. 5A and 5B.

As shown in FIG. 5A, discovery rates are similar for all the vegetal oils tested while recruitment, FIG. 5B, shows a preference as soybean oil resulted in the highest recruitment.

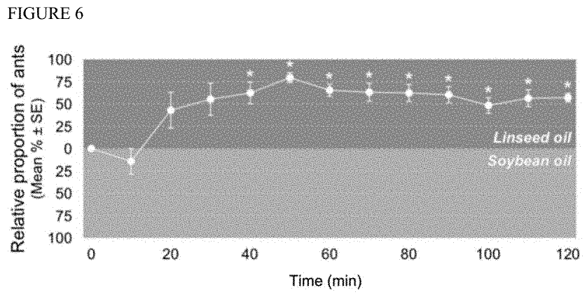

Another experiment was conducted in the laboratory to determine the preference for soybean or linseed oil. In this experiment, laboratory-maintained colonies of the red imported fire ant Solenopsis invicta were allowed to forage on squared arenas (80×80 cm). In each arena, 3 dishes contained linseed oil and 3 contained soybean oil. Every 10 minutes, the number of ants drinking oil in each dish were counted. The results are presented in FIG. 6. This experiment shows that under laboratory conditions, Solenopsis invicta has a clear preference for linseed oil over soybean oil. This preference is statistically significant after 40 minutes of foraging.

This series of experiments illustrate the high variability in oil preference depending on habitat. Depending on the context, we showed that ants can be attracted to oils either rich in linoleic acid (Soybean oil), α-linolenic acid (Linseed oil) or oleic acid (safflower oil). Hence, while the oil used may be tailored for a specific area, in order to increase efficiency the compositions may instead be formulated to target the largest variety of habitats/seasons by using a mixture of oils, for example 50% soybean oil-50% soybean oil as it is believed to contain balanced amounts of both essential fatty acids: 32% linoleic acid and 30% linolenic acid, and 20% of the non-essential oleic acid.

### Varying Ratios of Protein to Lipid

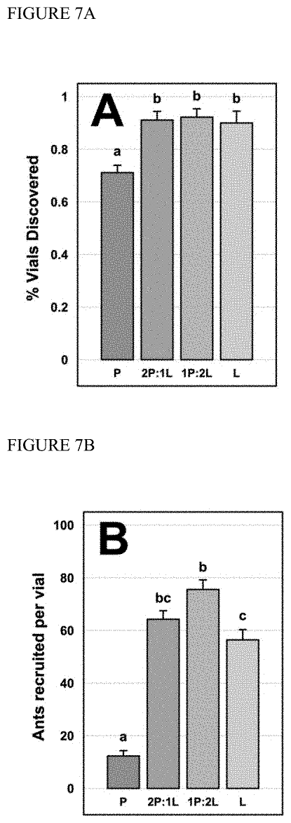

Different ratios of lipid to protein source were tested including 70% Whey (P); 2 parts 70% whey/1 part oil mix (50% linseed-50% soybean oil) (2P:1L); 1 part 70% whey/2 parts oil mix (50% linseed-50% soybean oil) (1P:2L); and 100% oil mix (50% linseed-50% soybean oil) (L). The results are shown in FIGS. 7A and 7B. These results show that the protein source alone and lipid component alone are not as attractive as the combination of both components with the best measured ratios of protein component to lipid component of 2:1 and 1:2. Therefore, the bait is effective over a large range of ratios, but it is more preferable to have elevated amounts of lipid.

### Example 2

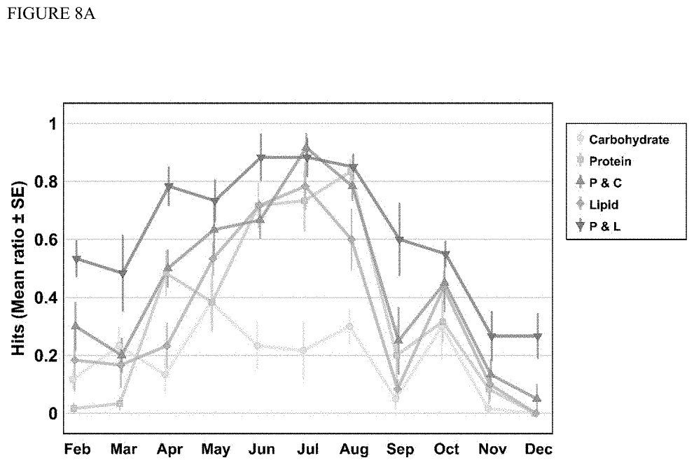

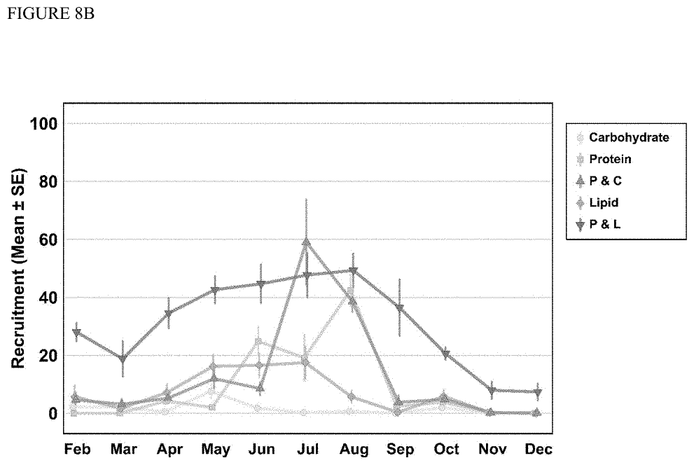

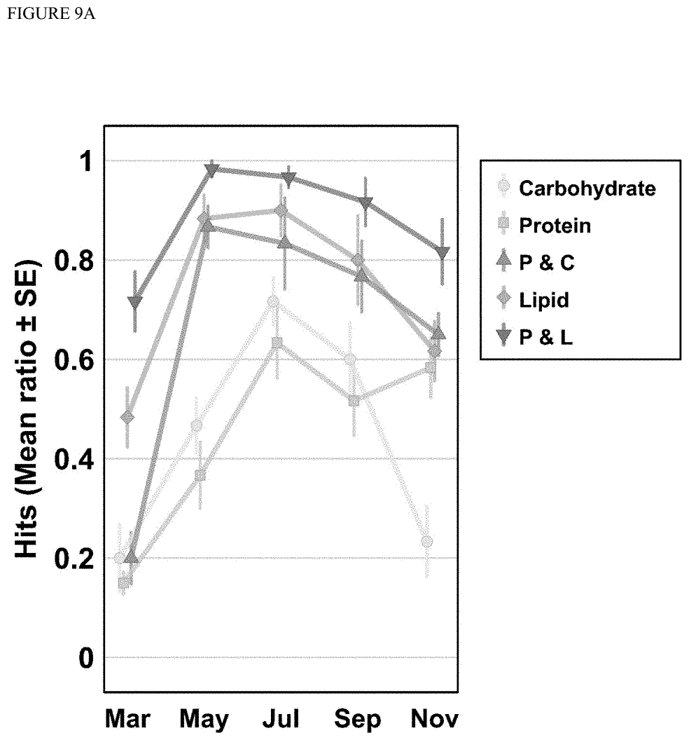

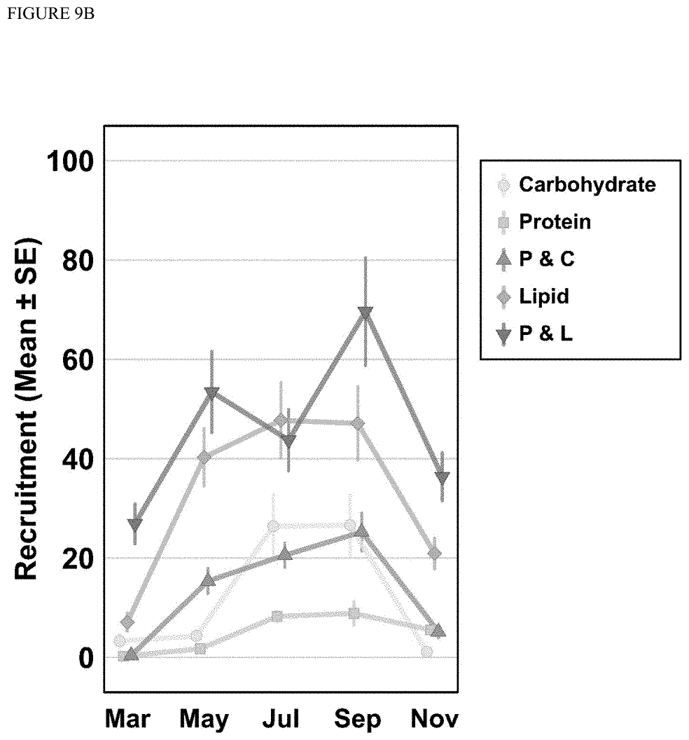

Ant food preferences tend to change over the course of the year and as a function of their habitat. To ensure that the association of protein and lipids was the combination of food always preferred by ants, we conducted the vial experiment at different times of the year and in 2 different habitats: a public lawn and a wooded area. Treatments included a carbohydrate component alone (sucrose solution 20%), a protein source alone (70% whey), a blend of the protein and the carbohydrate component (P&C: 2:1), a lipid component alone (50% linseed oil-50% soybean oil) and a blend of the protein and the lipid component (P&L: 2:1). Results for lawn habitats are shown in FIGS. 8A and 8B and for wooded habitats are shown in FIGS. 9A and 9B. As shown in the results, the disclosed bait formulation (P&L, orange on the graphics) is surprisingly effective all year round in two very different habitats. It further demonstrates that while the attraction to protein or lipid components alone vary significantly during the year and across habitats, the combination of a protein and a lipid component is more stable.

### Example 3

### Commercial Lawn:

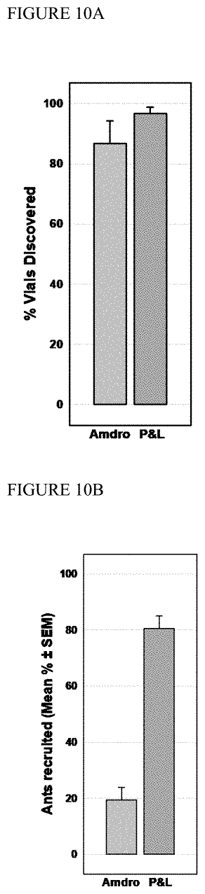

In this example is presented a comparison between the disclosed bait formulation (2 parts 70% whey protein/1-part oil mix (50% linseed-50% soybean oil) [P&L]) and the commercially available ant bait Amdro®. This experiment was run in a commercial lawn. As can be seen in FIGS. 10A and 10B, the bait formulation of the invention is similar in terms of discovery, but it is highly superior in recruitment.

### Residential Lawn:

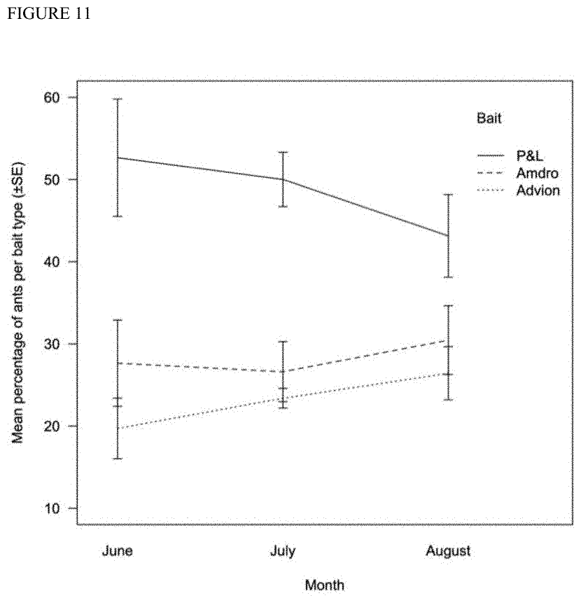

In this example is presented a comparison between the disclosed bait formulation (2 parts 70% whey protein/1-part oil mix (50% linseed-50% soybean oil) [P&L]) and the commercially available ant baits Amdro® and Advion®. This experiment was run in 5 different residential lawns in June, July and August. In this experiment, 20 replicates of each bait were used per transect. These results show that the bait formulation of the invention (P&L) is more attractive to ants than Amdro® and Advion® (FIG. 11).

Taken together, the compositions disclosed herein show a surprisingly higher efficacy than the currently available commercial ant baits.

In this example, 10588 ants were captured using the disclosed bait formulation. On average, 81% of these ants were Solenopsis invicta (the red imported fire ant), and 9% were Pheidole (the big-headed ant); both are considered pest and invasive ant species. The remaining 10% were Solenopsis spp. from the thief ant group (5%), Monomorium spp. (4%), plus a few (<1%) Nylanderia spp., Crematogaster spp. and Dorymyrmex spp. These results show that the disclosed bait formulation is surprisingly attractive to invasive ant species and pest ants.

What is claimed is:

1. An ant bait composition comprising:
a lipid;
a protein source; and
a filler.

2. The bait composition of claim 1, wherein the lipid is a fatty acid.

3. The bait composition of claim 2 wherein the fatty acid is lauric acid (12:0), myristic acid (14:0), palmitic acid (16:0), palmitoleic acid (16:1), margaric acid (17:0), heptadecenoic acid (17:1), stearic acid (18:0), oleic acid (18:1), linoleic acid (18:2), linolenic acid (18:3), octadecatetraenoic acid (18:4), arachidic acid (20:0), eicosenoic acid (20:1), eicosadienoic acid (20:2), eicosatetraenoic acid (20:4), eicosapentaenoic acid (20:5) (EPA), docosanoic acid (22:0), docosenoic acid (22:1), docosapentaenoic acid (22:5), docosahexaenoic acid (22:6) (DHA), tetracosanoic acid (24:0), and/or combinations thereof.

4. The bait compositions of claim 3, wherein the lipid comprises linoleic acid (18:2).

5. The bait composition of claim 2 wherein the lipid composition comprises linolenic acid (18:3).

6. The bait composition of claim 2 wherein said lipid composition comprises linoleic acid (18:2) and linolenic acid (18:3).

7. The bait composition of claim 6 wherein said linoleic acid (18:2) and Linolenic acid (18:3) are present in a ratio of about 3:1 to about 1:3.

8. The bait composition of claim 7, wherein the ratio is from about 2:1 to about 1:2.

9. The bait composition of claim 8, wherein the ratio is about 1:1.

10. The bait composition of claim 1, wherein the lipid is present in an amount of from about 5.0 wt. % to about 45 wt. %.

11. The bait composition of claim 1, wherein the lipid comprises soybean oil and/or linseed oil.

12. The bait composition of claim 1, wherein the protein source comprises one or more sources selected from the group consisting of milk proteins, plant proteins, animal proteins, and yeast.

13. The bait composition of claim 12, wherein the protein source is whey.

14. The bait composition of claim 12, wherein the protein source has a crude protein content of about 5 wt. % to about 95 wt. %.

15. The bait composition of claim 1, wherein the protein source to lipid ratio is from about 3:1 to about 1:3.

16. The bait composition of claim 15, wherein the protein source to lipid ratio is from about 2.5:1 to about 1:1.5.

17. The bait composition of claim 1, wherein the protein source is present in an amount of from about 20 wt. % to about 70 wt. %.

18. The bait composition of claim 1, wherein said filler is polyvinylpyrrolidone and/or a polysaccharide.

19. The bait composition of claim 1, wherein the filler is present in an amount of from about 5 wt. % to about 55 wt. %.

20. The bait composition of claim 1, further comprising an anti-oxidizing agent, a preservative, a coloring agent, a flavoring agent, and/or a feed attractant.

21. The bait composition of claim 1, wherein said bait composition is formulated as a paste, liquid, emulsion, suspension, pressed solid, granular, or hydrogel.

22. The bait composition of claim 1, wherein said bait is encapsulated in a capsule.

23. The bait composition of claim 22, wherein the capsule is biodegradable.

24. The bait composition of claim 22, wherein the capsule releases its contents under pressure.

25. The bait composition of claim 1, wherein the bait is attractive year-round.

26. The bait composition of claim 1, further comprising a station.

27. An insecticidal composition, comprising:
An ant bait, comprising:
a lipid;
a protein source; and
a filler; and
an insecticide.

28. The insecticidal composition of claim 27, wherein said insecticide is one or more of metaflumizone, fipronil, metaflumizone and/or fipronil.

29. The insecticidal composition of claim 27 wherein said insecticide is selected from the group of pyrethroids, GABA antagonist compounds, sodium channel blocker compounds, nicotinic receptor agonists/antagonists compounds, and uncoupler compounds. Particular preferred compositions contain at least one insecticide compound selected from the group consisting of bifenthrin, tefluthrin, α-cypermethrin, lambda cyhalotrin, ethiprole, pyriprole, fipronil, metaflumizone, acetamiprid, clothianidin, imidacloprid, nitenpyram, thiacloprid, thiamethoxam, dinetofuran, and/or chlorfenapyr.

30. The insecticidal composition of claim 27 wherein said pyrethroid includes one or more of bifenthrin, tefluthrin α-cypermethrin or lambda cyhalotrin.

31. The insecticidal composition of claim 27 wherein said 5 GABA antagonist compound includes one or more of ethiprole, pyriprole and fipronil.

32. The insecticidal composition or claim 27 wherein said insecticide is a sodium channel blocker compound.

33. The insecticidal composition of claim 27 wherein said insecticide is selected from the group of nicotinic receptor agonists/antagonist compounds including acetamiprid, clothianidin, imidacloprid, nitenpyram, thiacloprid, thiamethoxam and dinetofuran.

34. The insecticidal composition of claim 27 wherein said insecticidal component has a delay of 48 to 72 hours before killing.

35. A method of controlling ants, comprising:
introducing to the ants a bait, comprising:
a lipid;
a protein source; and
a filler; and
an insecticide.

36. The method of claim 35, wherein the insecticide is effective against ants selected from the group of Argentine ants (Linepithema humile), Big-headed ants (Pheidole spp.), Odorous house ant (Tapinoma sessile), Fire ants (Solenopsis spp.), Crazy ants (Paratrechina spp. and Nylanderia spp.) and Lasius spp. More preferably, at least two species of ants, which are present in the same area and are selected from Argentine ants (Linepithema humile), Big-headed ants (Pheidole spp.), Odorous house ant (Tapinoma sessile), Fire ants (Solenopsis spp.), Crazy ants (Paratrechina spp. and Nylanderia spp.) and Lasius spp.

37. The method of claim 35, wherein the introducing is through broadcast, bait stations, or liquid gravity feed system.

38. A method of capturing ants, comprising:
placing a station in a target area, wherein the station contains an ant bait comprising:
a lipid;
a protein source; and
a filler;
allowing a sufficient amount of time for the bait to attract the ants; and
collecting the station.

39. The method of claim 38, wherein the time is from about 5 minutes to about 120 minutes.

40. The method of claim 38, wherein the station is imbedded into the ground with an opening exposed to the surface of the ground.
